(19) United States
(12) Patent Application Publication
(10) Pub. No.: US 2015/0103670 A1
(43) Pub. Date: Apr. 16, 2015

(54) Method for Processing QoS, Application Server, QoS Control Network Element, and Mobile Network

(71) Applicant: Huawei Technologies Co., Ltd., Shenzhen (CN)

(72) Inventors: Wenfu Wu, Shanghai (CN); Yan Wang, Shanghai (CN); Liping Yuan, Shanghai (CN); Yan Li, Beijing (CN)

(21) Appl. No.: 14/579,931

(22) Filed: Dec. 22, 2014

Related U.S. Application Data
(63) Continuation of application No. PCT/CN2012/077882, filed on Jun. 29, 2012.

(51) Int. Cl. H04W 28/02; H04L 12/853

(52) U.S. Cl. CPC H04W 28/0268; H04L 47/2416
USPC 370/236.1

(57) ABSTRACT

A method for processing quality of service, an application server, a QoS control network element, and a mobile network id disclosed. The method includes: obtaining initial quality of service QoS information of a user equipment in a mobile network; determining, according to the initial QoS information, to request the mobile network to increase a QoS level of the user equipment; sending a QoS improving request to a QoS control network element to request for increasing the QoS level of the user equipment; and receiving a QoS improving response, where the QoS improving response includes enhanced QoS information assigned by the mobile network for the user equipment. The method for processing quality of service, the application server, the QoS control network element, and the mobile network according to embodiments of the present invention can dynamically adjust the QoS level of the user equipment, thereby improving user experience.

This application is a continuation of International Application No. PCT/CN2012/077882, filed on Jun. 29, 2012, which is hereby incorporated by reference in its entirety.

### TECHNICAL FIELD

The present invention relates to the field of communications, and in particular, to a method for processing quality of service QoS, an application server, a QoS control network element, and a mobile network.

### BACKGROUND

In a system architecture evolution (SAE) network of the 3rd generation partnership project (3GPP), quality of service (QoS) of a user equipment in a mobile network is controlled based on static subscription QoS information. For example, if a maximum bandwidth of a video service subscribed to by the user equipment in the mobile network is 2M, when the user equipment carries out the video service, a maximum bandwidth assigned by the mobile network for the user equipment will not exceed 2M even if a bandwidth requested by the user equipment exceeds 2M.

In the following application scenario, for example, user A is a common user in the mobile network, whose maximum allowable bandwidth is 1M; user B is a gold user in the mobile network, whose maximum allowable bandwidth is 3M; and both user A and user B are paying users in a video website, and a video provider guarantees a bandwidth of 2M. When user A and user B access an application server in the video website through the mobile network, limited by static subscription in the mobile network, a maximum bandwidth assigned by the mobile network to user A is not larger than 1M, so user A cannot enjoy 2M bandwidth experience guaranteed by the video website; and a maximum bandwidth assigned by the mobile network to user B is not larger than 3M, so user B may enjoy the 2M bandwidth experience guaranteed by the video website.

That is, in the current mobile network, QoS control is carried out based on static QoS subscription data, and cannot be dynamically adjusted according to a QoS requirement of an industrial user (an application provider), so user experience is poor.

### SUMMARY

Embodiments of the present invention provide a method for processing quality of service, an application server, a QoS control network element, and a mobile network, capable of adjusting a QoS level of a user equipment.

In one aspect, an embodiment of the present invention provides a method for processing quality of service, which includes: obtaining initial quality of service QoS information of a user equipment in a mobile network. The method further includes determining, according to the initial QoS information, to request the mobile network to increase a QoS level of the user equipment; sending a QoS improving request to a QoS control network element. The QoS improving request is used to request for increasing the QoS level of the user equipment. The method further includes receiving a QoS improving response sent by the QoS control network element, where the QoS improving response includes enhanced QoS information assigned by the mobile network for the user equipment.

In another aspect, an embodiment of the present invention provides a method for processing quality of service, which includes receiving a QoS improving request sent by an application server. The QoS improving request is used to request a mobile network to increase a QoS level of a user equipment. The method further includes determining, according to the QoS improving request and a QoS enhancement protocol between the application server and the mobile network, enhanced QoS information assigned by the mobile network for the user equipment; and sending a QoS improving response to the application server, where the QoS improving response includes the enhanced QoS information.

In still another aspect, an embodiment of the present invention provides a method for processing quality of service, which includes receiving QoS enhancement indication information sent by a QoS control network element. The QoS enhancement indication information is sent after the QoS control network element receives a QoS improving request sent by an application server and determines to increase a QoS level of a user equipment. The method further includes collecting, according to the QoS enhancement indication information, charging information of the user equipment after the QoS level is increased; and sending the charging information to a charging system.

In still another aspect, an embodiment of the present invention provides an application server, which includes an obtaining module configured to obtain initial quality of service QoS information of a user equipment in a mobile network. A determining module is configured to determine, according to the initial QoS information, to request the mobile network to increase a QoS level of the user equipment. A sending module is configured to send a QoS improving request to a QoS control network element. The QoS improving request is used to request for increasing the QoS level of the user equipment. A receiving module is configured to receive a QoS improving response sent by the QoS control network element. The QoS improving response includes enhanced QoS information assigned by the mobile network for the user equipment.

In still another aspect, an embodiment of the present invention provides a QoS control network element, which includes a first receiving module configured to receive a QoS improving request sent by an application server. The QoS improving request is used to request a mobile network to increase a QoS level of a user equipment. A first determining module is configured to determine, according to the QoS improving request and a QoS enhancement protocol between the application server and the mobile network, enhanced QoS information assigned by the mobile network for the user equipment. A first sending module is configured to send a QoS improving response to the application server. The QoS improving response includes the enhanced QoS information.

In still another aspect, an embodiment of the present invention provides a mobile network, which includes a receiving module configured to receive QoS enhancement indication information sent by a QoS control network element. The QoS enhancement indication information is sent after the QoS control network element receives a QoS improving request sent by the application server and determines to increase a QoS level of a user equipment. A collecting module is configured to collect, according to the QoS enhancement indication information, charging information of the user equipment after the QoS level is increased. A sending module is configured to send the charging information to a charging system.

Based on the foregoing technical solution, in the method for processing quality of service, the application server, the QoS control network element, and the mobile network in the embodiments of the present invention, the application server requests the QoS control network element to increase the QoS level of the user equipment, so that the mobile network can dynamically adjust the QoS level of the user equipment, thereby improving user experience, and facilitating promotion of an application service.

### BRIEF DESCRIPTION OF THE DRAWINGS

To describe the technical solutions in the embodiments of the present invention more clearly, the following briefly introduces accompanying drawings required for describing the embodiments of the present invention. Apparently, the accompanying drawings in the following description show merely some embodiments of the present invention, and a person of ordinary skill in the art may still derive other drawings according to these accompanying drawings without creative efforts.

FIG. 1 is a schematic architectural diagram of an application scenario according to an embodiment of the present invention;

FIG. 2 is a schematic flowchart of a method for processing QoS according to an embodiment of the present invention;

FIG. 3 is a schematic flowchart of a method for obtaining initial QoS information according to an embodiment of the present invention;

FIG. 4 is another schematic flowchart of a method for obtaining initial QoS information according to an embodiment of the present invention;

FIG. 5 is another schematic flowchart of a method for processing QoS according to an embodiment of the present invention;

FIG. 6 is a schematic flowchart of a method for processing QoS according to another embodiment of the present invention;

FIG. 7 is another schematic flowchart of a method for processing QoS according to another embodiment of the present invention;

FIG. 8 is still another schematic flowchart of a method for processing QoS according to another embodiment of the present invention;

FIG. 9 is still another schematic flowchart of a method for processing QoS according to another embodiment of the present invention;

FIG. 10 is a schematic flowchart of a method for processing QoS according to still another embodiment of the present invention;

FIG. 11 is a schematic flowchart of a method for processing QoS according to still another embodiment of the present invention;

FIG. 12 is a schematic block diagram of an application server according to an embodiment of the present invention;

FIG. 13 is a schematic block diagram of an obtaining module according to an embodiment of the present invention;

FIG. 14 is another schematic block diagram of an obtaining module according to an embodiment of the present invention;

FIG. 15 is a schematic block diagram of a determining module according to an embodiment of the present invention;

FIG. 16 is another schematic block diagram of an application server according to an embodiment of the present invention;

FIG. 17 is a schematic block diagram of a QoS control network element according to an embodiment of the present invention;

FIG. 18 is another schematic block diagram of a QoS control network element according to an embodiment of the present invention;

FIG. 19 is still another schematic block diagram of a QoS control network element according to an embodiment of the present invention;

FIG. 20 is still another schematic block diagram of a QoS control network element according to an embodiment of the present invention;

FIG. 21 is still another schematic block diagram of a QoS control network element according to an embodiment of the present invention; and

FIG. 22 is a schematic block diagram of a mobile network according to an embodiment of the present invention.

### DETAILED DESCRIPTION OF ILLUSTRATIVE EMBODIMENTS

The following clearly describes the technical solutions in the embodiments of the present invention with reference to the accompanying drawings in the embodiments of the present invention. Apparently, the described embodiments are merely a part rather than all of the embodiments of the present invention. All other embodiments obtained by a person of ordinary skill in the art based on the embodiments of the present invention without creative efforts shall fall within the protection scope of the present invention.

It should be understood that, the technical solutions in the embodiments of the present invention may be applied to various communications systems, such as a Global System for Mobile Communications (GSM), a Code Division Multiple Access (CDMA) system, a Wideband Code Division Multiple Access (WCDMA) system, a General Packet Radio Service (GPRS) system, a Long Term Evolution (LTE) system, an LTE frequency division duplex (FDD) system, an LTE time division duplex (TDD) system, a Universal Mobile Telecommunications System (UMTS), and a Worldwide Interoperability For Microwave Access (WiMAX) communications system.

It should be understood that the embodiments of the present invention use an application in an SAE system as an example for description, but the present invention is not limited thereto. In addition, the terms “system” and “network” herein may be used interchangeably in the specification. The term “and/or” herein is merely an association for describing associated objects, representing that three relationships may exist. For example, A and/or B may represent the following three cases: A exists alone, A and B exist at the same time, and B exists alone. In addition, the character “/” herein generally represents that associated objects before and after “/” are in an “or” relationship.

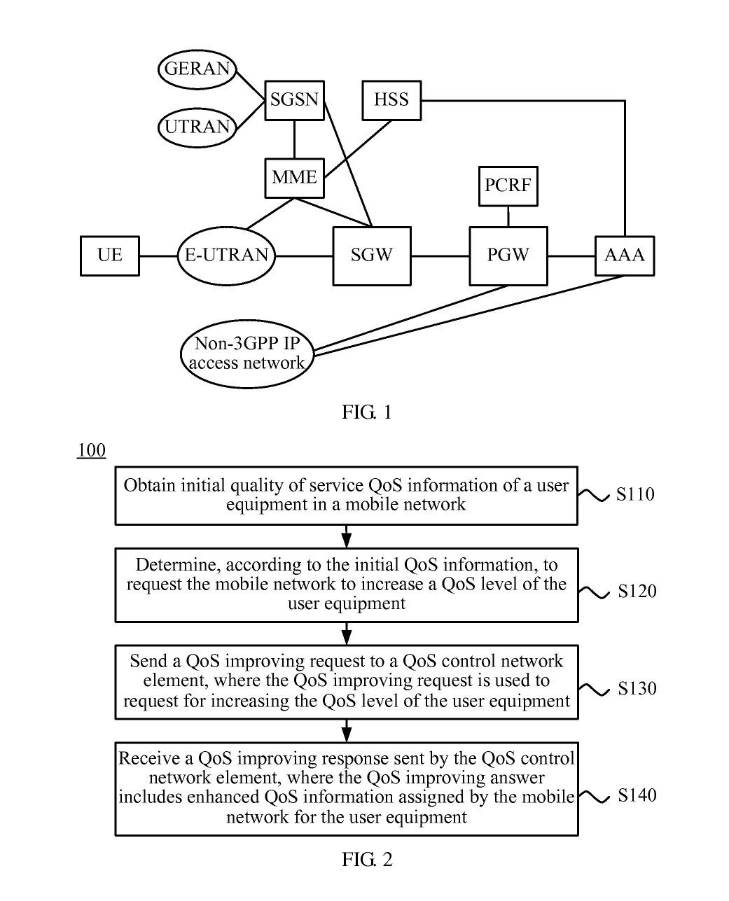

FIG. 1 shows a schematic architectural diagram of an application scenario according to an embodiment of the present invention. As shown in FIG. 1, the SAE system may include: an evolved UMTS terrestrial radio access network (E-UTRAN, where the Universal Mobile Telecommunications System is “UMTS” for short), a mobility management entity(MME), a serving gateway (SGW), a packet data network gateway (PGW), a policy and charging rule function (PCRF), a home subscriber server (HSS), and so on.

The E-UTRAN is used to implement all radio related functions of an evolved network; the MME is in charge of mobility management of a control plane, including managing user context and a mobile state, assigning a temporary user identity, and so on; the SGW is a user plane anchor between 3GPP access networks, for terminating an interface of the E-TURAN; the PGW is a user plane anchor between a 3GPP access network and a non-3GPP access network, for terminating an interface with an external packet data network (PDN). The PCRF is used for policy control decision function and flow-based charging control function; and the HSS is used to store user subscription information.

In the SAE system architecture shown in FIG. 1, a UMTS terrestrial radio access network (UTRAN) and a GSM/EDGE radio access network (GERAN, where the enhanced data rate for GSM evolution is “EDGE” for short) are used to implement all radio related functions in an existing GPRS/UMTS network; a serving general packet radio service supporting node (SGSN) is used to implement functions such as routing and forwarding, mobility management, session management, and user information storage in the GPRS/UMTS network; a non-3GPP IP access network (Non-3GPP IP Access) mainly includes some access networks defined by non-3GPP organizations, for example, a wireless local area network (WLAN), a WiMAX network, and a CDMA network; and an authentication, authorization and accounting server (AAA Server) is used to execute access authentication, authorization, and accounting functions for a UE.

FIG. 2 shows a method 100 for processing QoS according to an embodiment of the present invention, where the method 100 may be executed by an application server. As shown in FIG. 2, the method 100 includes the following steps.

S110: Obtain initial quality of service QoS information of a user equipment in a mobile network.

S120: Determine, according to the initial QoS information, to request the mobile network to increase a QoS level of the user equipment.

S130: Send a QoS improving request to a QoS control network element, where the QoS improving request is used to request for increasing the QoS level of the user equipment.

S140: Receive a QoS improving response sent by the QoS control network element, where the QoS improving response includes enhanced QoS information assigned by the mobile network for the user equipment.

When the user equipment initiates an application request to the application server to request for performing an application service, or when the application server pushes an application service to the user equipment, or in another application scenario, the application server may first obtain the initial QoS information of the user equipment in the mobile network, and determine whether to request the mobile network to increase the QoS level of the user equipment; if the application server determines to request to increase the QoS level of the user equipment, the application server may send a QoS improving request to the QoS control network element to request for increasing the QoS level of the user equipment, and in addition, the application server may receive a QoS improving response sent by the QoS control network element, where the QoS improving response includes the enhanced QoS information assigned by the mobile network for the user equipment; and if the application server determines not to increase the QoS level of the user equipment, the application server may continue to provide the application service to the user equipment.

Therefore, in the method for processing quality of service according to the embodiment of the present invention, the application server requests the QoS control network element to increase the QoS level of the user equipment, so that the mobile network can dynamically adjust the QoS level of the user equipment, thereby improving user experience, and facilitating promotion of the application service.

In addition, through the method for processing QoS according to the embodiment of the present invention, a mobile operator can charge a fee for increasing the QoS level, thereby monetizing a mobile broadband channel capability thereof, and increasing value thereof in the mobile Internet industry chain. Moreover, by increasing the QoS level through a request, a user with a higher priority is provided with higher QoS, so that the user with a higher priority has better user experience; and in addition, an application provider attracts a terminal user to increase a subscriber category (empirical value) in an application, which facilitates the promotion of the application service, and can also improve income of the application provider.

In the embodiment of the present invention, the application server may be a video server, or may also be a File Transfer Protocol (FTP) server. The FTP server is a dedicated server for providing various files for a user. The FTP server usually stores a large amount of files, for example, software, MP3, movies, and programs. The application server may also be a mail server or another server, and the present invention is not limited thereto. In another aspect, in the embodiment of the present invention, the application service or application content may be video, software, MP3, movie, program, or mail content, or the like, and the present invention is not limited thereto.

In the embodiments of the present invention, the QoS control network element may be a PCRF, a capability open platform, a service development platform, a service gateway, or the like, and the present invention is not limited thereto. For example, the QoS control network element may also be another open platform.

It should be understood that, in the embodiment of the present invention, the term “initial QoS information” represents QoS information of the user equipment in the mobile network before the QoS control network element determines to change the QoS information, for example, current QoS information when the user equipment initiates a service request, and the embodiment of the present invention is not limited thereto.

It should be understood that, in the embodiments of the present invention, if the QoS control network element in the present invention is a PCRF, interaction between the application server and the QoS control network element may be implemented through an open platform. For example, the application server sends a QoS improving request to the open platform, where the QoS improving request is used to request for increase the QoS level of the user equipment, and the open platform then sends the QoS improving request to the QoS control network element.

It should be further understood that, in the embodiments of the present invention, information may be transmitted between network elements through a message interface, or transmitted through an API interface, and may also be transmitted through an interface of another type or in another manner, and the embodiment of the present invention is not limited thereto.

It should be further understood that, in the embodiments of the present invention, various types of “requests” and “responses” merely refer to a certain carrier, for example, a message, for carrying information or content, and are not limited to specific names. For example, the “QoS improving request” merely represents a request for requesting to increase the QoS level of the user equipment, and is not limited to a request named a QoS improving request. In the same way, the “QoS improving response” merely represents an response containing the enhanced QoS information assigned by the mobile network for the user equipment, and is not limited to an response named a QoS improving response.

In addition, the term “response” is not limited to a response or a reply to a “request”, but may also refer to some information or content, or refers to a carrier, such as a message, which contains some information or content. For example, the QoS improving response may represent a response to the QoS improving request, may also represent the enhanced QoS information, and may further represent a message containing the enhanced QoS information, or a carrier in another form containing the enhanced QoS information, and the present invention is not limited thereto.

In S110, the application server obtains the initial QoS information of the user equipment in the mobile network.

In the embodiment of the present invention, optionally, the initial QoS information includes at least one of the following information: subscription QoS information of the user equipment in the mobile network, assignment QoS information assigned by the mobile network for the user equipment, available QoS information of the user equipment in the mobile network, and charging package information of the user equipment in the mobile network. It should be understood that, the initial QoS information is, for example, bandwidth information. In the embodiment of the present invention, the bandwidth information is used as an example of the initial QoS information for description, but the present invention is not limited thereto. It should be further understood that, the term “available QoS information” refers to QoS information that can be used by the user equipment in the mobile network.

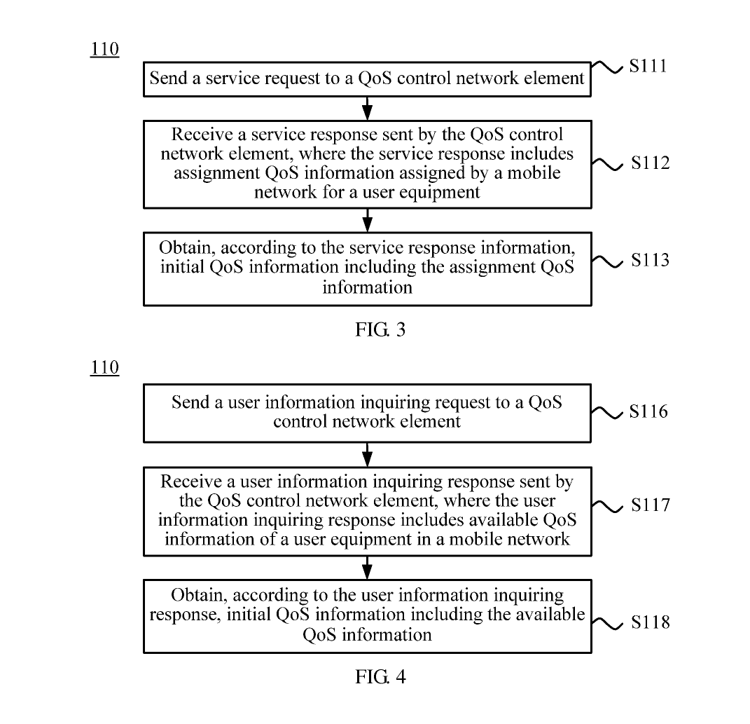

The following describes a method for an application server to obtain initial QoS information in detail with reference to FIG. 3 and FIG. 4.

As shown in FIG. 3, a method 110 for an application server to obtain initial QoS information includes the following steps.

S111: Send a service request to a QoS control network element.

S112: Receive a service response sent by the QoS control network element, where the service response includes assignment QoS information assigned by the mobile network for the user equipment.

S113: Obtain the initial QoS information including the assignment QoS information according to information of the service response.

In S111, the application server sends the service request to the QoS control network element. The QoS control network element may be a network element such as a PCRF, a service gateway, a capability development platform or a service development platform, and the present invention is not limited thereto. The service request may include a service type and QoS required for a service, for example, a required bandwidth; and the service request may further include a service identity, and the like.

In the embodiment of the present invention, the mobile operator may provide a QoS request application programming interface (API) for a third-party application (such as the application server in the embodiment of the present invention), and the API may include parameters such as a service type requested by the third-party service and QoS needed by the service. The third-party application requests, by invoking the API, the mobile network to assign QoS, such as a bandwidth, to the requested service.

In S112, the application server receives the service response sent by the QoS control network element, where the service response includes the assignment QoS information assigned by the mobile network for the user equipment. Optionally, the service response further includes subscription QoS information of the user equipment in the mobile network and/or charging package information of the user equipment in the mobile network.

In the embodiment of the present invention, the mobile operator may provide a QoS notification API for the third-party application, where the API may include parameters such as assignment QoS information (for example, a bandwidth) assigned by the mobile network to the application service; and the mobile network may notify, through the API, the third-party application (such as the application server in the embodiment of the present invention) of the assignment QoS information assigned by the mobile network to the application service.

It should be understood that, in the embodiment of the present invention, the QoS control network element may also notify, in another manner, the application server of the assignment QoS information assigned by the mobile network for the user equipment. The present invention does not limit a specific notification manner.

In S113, the application server obtains, according to the service response information, the initial QoS information including the assignment QoS information. Optionally, the initial QoS information further includes the subscription QoS information and/or the charging package information of the user equipment in the mobile network.

Therefore, the application server can obtain the initial QoS information including the assignment QoS information, the subscription QoS information and/or the charging package information of the user equipment in the mobile network, so that the application server can determine whether to request the mobile network to increase the QoS level of the user equipment.

FIG. 4 shows another schematic flowchart of a method 110 for obtaining initial QoS information according to an embodiment of the present invention. The method 110 may be executed by an application server. As shown in FIG. 4, the method 110 includes the following steps.

S116: Send a user information inquiring request to the QoS control network element.

S117: Receive a user information inquiring response sent by the QoS control network element, where the user information inquiring response includes available QoS information of the user equipment in the mobile network.

S118: Obtain, according to the user information inquiring response, the initial QoS information including the available QoS information.

In S116, the application server sends the user information inquiring request to the QoS control network element (such as the PCRF or capability open platform), so as to request for inquiring information of the user equipment, where the user information inquiring request may include an identifier of the user equipment, and the identifier is, for example, a uniform resource identifier (URI), a fully qualified domain name/full name domain name (FQDN), or a mobile subscriber number.

In the embodiment of the present invention, the mobile operator may provide a user information inquiring request API for the third-party application, where the API may include the identifier of the user equipment, and the third-party application (such as the application server in the embodiment of the present invention) may request, by invoking the API, the mobile network to provide information of the user equipment.

In S117, the application server receives a user information inquiring response sent by the QoS control network element, where the user information inquiring response includes available QoS information of the user equipment in the mobile network. Optionally, the user information inquiring response may further include subscription QoS information of the user equipment in the mobile network and/or charging package information of the user equipment in the mobile network.

In the embodiment of the present invention, the mobile operator may provide a user information notification API for the third-party application, where the API may include available QoS information of the user equipment in the mobile network, and may further include subscription QoS information (such as a subscribed bandwidth), charging package information, and so on. The mobile network may notify, through the API, the third-party application of the information of the user equipment.

It should be understood that, in the embodiment of the present invention, the QoS control network element may also notify, in another manner, the application server of the available QoS information of the user equipment in the mobile network, and the present invention does not limit a specific notification manner.

In S118, the application server obtains the initial QoS information including the available QoS information according to the user information inquiring response. Optionally, the initial QoS information further includes the subscription QoS information and/or the charging package information of the user equipment in the mobile network.

It should be understood that, the application server may further obtain the initial QoS information through another method. For example, the mobile network actively notifies the application server of the initial QoS information, or the application server reads the initial QoS information locally.

Therefore, the application server is capable of obtaining the initial QoS information including the assignment QoS information, the subscription QoS information and/or the charging package information, thereby being capable of determining whether to request the mobile network to increase the QoS level of the user equipment.

In S120, the application server determines, according to the initial QoS information, to request the mobile network to increase the QoS level of the user equipment.

In the embodiment of the present invention, the QoS level of the user equipment includes a bandwidth allowed to be used by the user equipment, and/or a subscriber category of the user equipment. Optionally, the application server determines, according to the initial QoS information, to request the mobile network to increase the bandwidth allowed to be used by the user equipment, and/or to increase the subscriber category of the user equipment, for example, upgrading the subscriber category of the user equipment from a bronze user category to a silver user category or a gold user category.

In the embodiment of the present invention, optionally, the application server determines, according to the initial QoS information and a preset rule, to request the mobile network to increase the QoS level of the user equipment. It should be understood that, the preset rule may be a rule related to the initial QoS information, and will be described in detail below, but the embodiment of the present invention is not limited thereto.

It should be understood that, the QoS improving request may include QoS or a subscriber category that the application server expects the mobile network to increase for the user equipment. However, it should be understood at the same time that, the QoS control network element may ultimately determine the enhanced QoS information assigned to the user equipment according to various parameters apart from the QoS improving request of the application server. For example, the QoS control network element determines the enhanced QoS information by further taking into consideration parameters such as the initial QoS information.

In the embodiment of the present invention, optionally, when the assignment QoS information, included in the initial QoS information and assigned by the mobile network for the user equipment, does not meet a QoS demand of a service, it is determined to request the mobile network to increase the QoS level of the user equipment; or when the available QoS information, included in the initial QoS information, of the user equipment in the mobile network does not meet the QoS demand of the service, it is determined to request the mobile network to increase the QoS level of the user equipment; or when the subscription QoS information, included in the initial QoS information, of the user equipment in the mobile network does not meet the QoS demand of the service, it is determined to request the mobile network to increase the QoS level of the user equipment; or when the charging package information included in the initial QoS information does not meet a charging package requirement, it is determined to request the mobile network to increase the QoS level of the user equipment.

In S130, the application server sends a QoS improving request to the QoS control network element, where the QoS improving request is used to request to increase the QoS level of the user equipment. The QoS improving request may include information such as a bandwidth needed by the service.

The mobile operator may provide a QoS enhancement API for the third-party application, where the API may include enhanced QoS information (such as a bandwidth or a subscriber category) required by the third-party application, and the third-party application may request, by invoking the API, the mobile network to increase the QoS level of the user equipment.

In S140, the application server receives a QoS improving response sent by the QoS control network element, where the QoS improving response includes enhanced QoS information assigned by the mobile network for the user equipment.

It should be understood that, in the embodiment of the present invention, the QoS control network element may also notify, in another manner, the application server of the enhanced QoS information assigned by the mobile network for the user equipment, for example, notifying, by invoking a QoS notification API, the application server of the enhanced QoS information assigned by the mobile network for the user equipment. The present invention does not limit a specific notification manner.

Therefore, in the method for processing quality of service according to the embodiment of the present invention, the application server requests the QoS control network element to increase the QoS level of the user equipment, so that the mobile network can dynamically adjust the QoS level of the user equipment, thereby improving user experience, and facilitating promotion of the application service.

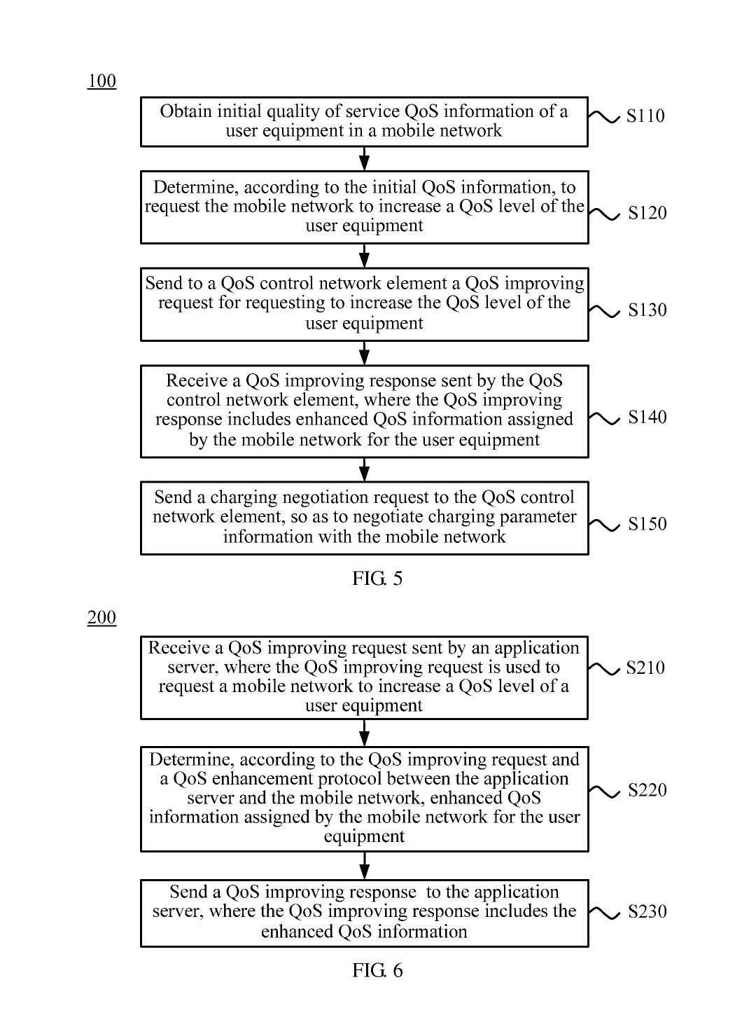

In the embodiment of the present invention, optionally, as shown in FIG. 5, the method 100 for processing quality of service further includes the following steps.

S150: Send a charging negotiation request to the QoS control network element, so as to negotiate charging parameter information with the mobile network.

In the embodiment of the present invention, the application provider sends the charging negotiation request to the QoS control network element, so as to negotiate charging related parameter information with the mobile operator, for example, negotiating whether to charge according to a duration of enhanced QoS (for example, charging 0.1 CNY for 10 minutes of enhanced QoS), or charge according to the number of QoS enhanced times (for example, charging 0.1 CNY for one time of enhanced QoS).

Specifically, charging mode negotiation between the application provider and the mobile operator may be processed as follows: the mobile operator may provide a charging negotiation API to the third-party application, where the API may include: a charging mode, such as an online mode or an offline mode; a measurement mode, such as a data volume, a data duration, the data volume and data duration, or another event; and a charging package (for example, 10 yuan/100M/month or 1 yuan/one time of enhanced QoS). The third-party application may negotiate the charging parameter information with the mobile network operator by invoking the API.

For example, the application provider obtains, by invoking the API, charging parameter information (such as the charging package information) provided by the mobile operator, then the application provider selects the charging parameter information (for example, selecting a charging package), and the application provider sends the selected charging parameter information to the mobile operator; or, the application provider sends, by invoking the API, charging parameter information expected by the application provider to the mobile operator, and the mobile operator determines the charging parameter information requested by the application provider, and sends the determined charging parameter information to the application provider, so that the third-party application and the mobile operator complete charging parameter information negotiation.

It should be understood that, in the embodiment of the present invention, if the QoS control network element is a PCRF, the application server may send a charging negotiation request to an open platform, so as to negotiate the charging parameter information with the mobile network. In this scenario, the charging parameter negotiation is performed between the application server and the open platform.

It should be understood that, the method for processing QoS according to the embodiment of the present invention further includes processes such as receiving, by the application server, the charging information sent by the QoS control network element.

It should be understood that, in the embodiment of the present invention, information may be transmitted between network elements through a message interface, or transmitted through an API interface, and may also be transmitted through an interface of another type, and the embodiment of the present invention is not limited thereto.

It should be understood that, in the embodiment of the present invention, names of the APIs or messages between the network elements are merely exemplary, and the embodiment of the present invention is not limited to specific names of the APIs or messages.

It should be further understood that in the embodiments of the present invention, serial numbers of the above processes do not indicate an execution sequence. The execution sequence of the processes should be determined based on functions and internal logic thereof, and should not constitute any limitation on an implementation process of the embodiments of the present invention. For example, the application provider and the mobile operator may negotiate the charging parameter information first, and then perform the QoS enhancement processing.

Therefore, in the method for processing quality of service according to the embodiment of the present invention, the application server requests the QoS control network element to increase the QoS level of the user equipment, so that the mobile network can dynamically adjust the QoS level of the user equipment, thereby improving user experience, and facilitating promotion of the application service.

With reference to FIG. 1 to FIG. 5, the method for processing quality of service according to the embodiment of the present invention is described above from the perspective of the application server. The following describes the method for processing quality of service according to the embodiment of the present invention from the perspective of the QoS control network element with reference to FIG. 6 to FIG. 9.

As shown in FIG. 6, a method 200 for processing QoS according to the embodiment of the present invention may be executed by a QoS control network element, and the QoS control network element is, for example, a PCRF, a service gateway, a capability open platform, or a service open platform. The method 200 includes the following steps.

S210: Receive a QoS improving request sent by an application server, where the QoS improving request is used to request a mobile network to increase a QoS level of a user equipment.

S220: Determine, according to the QoS improving request and a QoS enhancement protocol between the application server and the mobile network, enhanced QoS information assigned by the mobile network for the user equipment.

S230: Send a QoS improving response to the application server, where the QoS improving response includes the enhanced QoS information.

Therefore, in the method for processing quality of service according to the embodiment of the present invention, the application server requests the QoS control network element to increase the QoS level of the user equipment, so that the mobile network can dynamically adjust the QoS level of the user equipment, thereby improving user experience, and facilitating promotion of the application service.

In S210, the QoS control network element receives the QoS improving request sent by the application server, where the QoS improving request is used to request the mobile network to increase the QoS level of the user equipment.

The QoS control network element receives, through, for example, the QoS enhancement API, the QoS improving request sent by the application server. The QoS improving request may include an enhanced QoS parameter, for example, information, such as a bandwidth and a subscriber category, which needs to be increased.

In S220, the QoS control network element determines, according to the QoS improving request and the QoS enhancement protocol between the application server and the mobile network, the enhanced QoS information assigned by the mobile network for the user equipment.

In the embodiment of the present invention, the QoS enhancement protocol between the application server and the mobile network includes a QoS enhanced charging package, and so on. The QoS control network element may determine, according to the QoS improving request and the QoS enhancement protocol, the enhanced QoS information assigned by the mobile network for the user equipment.

For example, the QoS enhanced charging package is specifically: the package is 500 yuan, which can increase the bandwidth of the user equipment to 4M for 1000 times. If the QoS improving request sent by the application server requests to increase the bandwidth to 4M, the QoS control network element may determine, according to the QoS improving request and the QoS enhancement protocol, that the bandwidth contained in the enhanced QoS information is 4M; and if the QoS improving request sent by the application server requests to increase the bandwidth to 5M, the QoS control network element determines, according to the QoS improving request and the QoS enhancement protocol, that the bandwidth contained in the enhanced QoS information can only be 4M.

It should be understood that, the above example is merely exemplary, and the QoS control network element may further determine the enhanced QoS information according to other information. For example, the QoS control network element may determine that the bandwidth contained in the enhanced QoS information is 3M by considering a network load or network capability, even if the QoS enhanced charging package allows a bandwidth of 4M.

In S230, the QoS control network element sends the QoS improving response to the application server, where the QoS improving response includes the enhanced QoS information.

It should be understood that, in the embodiment of the present invention, the QoS control network element may also notify the application server of the enhanced QoS information in another manner, for example, notifying the application server of the enhanced QoS information by invoking a QoS notification API. The present invention does not limit a specific notification manner.

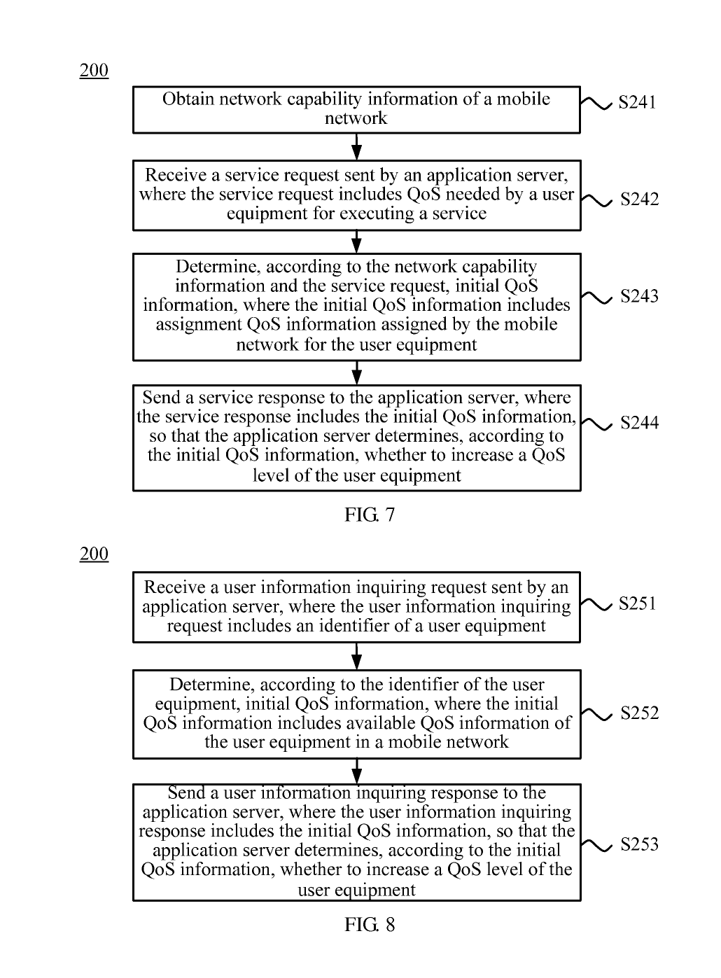

In the embodiment of the present invention, optionally, as shown in FIG. 7, the method 200 for processing QoS according to the embodiment of the present invention further includes the following steps.

S241: Obtain network capability information of the mobile network.

S242: Receive a service request sent by the application server, where the service request includes QoS needed by the user equipment for executing a service.

S243: Determine, according to the network capability information and the service request, the initial QoS information, where the initial QoS information includes assignment QoS information assigned by the mobile network for the user equipment.

S244: Send a service response to the application server, where the service response includes the initial QoS information, so that the application server determines, according to the initial QoS information, whether to increase a QoS level of the user equipment.

It should be understood that, in the embodiment of the present invention, the QoS control network element may also notify the application server of the initial QoS information in another manner, for example, notifying the application server of the initial QoS information by invoking a QoS notification API. The present invention does not limit a specific notification manner.

In the embodiment of the present invention, optionally, the network capability information includes at least one of load information of a cell, load information of an access network element, QoS supported by an access network, load information of a gateway network element, and QoS supported by a gateway network element.

The QoS control network element may obtain the network capability information in multiple manners. For example, the mobile network reports information such as a network load or network capability to the QoS control network element (such as a PCRF or a capability open platform). For example, the access network element reports load information of a cell or load information of an access network element to the QoS control network element; or the access network element reports QoS information that can be supported (such as a supported maximum bandwidth) by the access network to the QoS control network element; or a gateway device of a core network may report load information of a gateway network element to the QoS control network element; or the gateway device of the core network may report QoS information that can be supported (such as a supported maximum bandwidth) by the gateway network element to the QoS control network element.

In the embodiment of the present invention, the QoS control network element determines, according to the network capability information and the service request, the initial QoS information, where the initial QoS information includes assignment QoS information assigned by the mobile network for the user equipment. For example, the QoS control network element may determine, based on the network load or network capability, the QoS that can be assigned by the mobile network. For example, if the network load is high, it is determined that the mobile network assigns low QoS (such as a low bandwidth) to the service requested by the user equipment; and if the network load is low, it is determined that the mobile network assigns high QoS (such as a high bandwidth) to the service requested by the user equipment.

Therefore, the QoS control network element sends the initial QoS information to the application server, so that the application server can determine, according to the initial QoS information, whether to increase the QoS level of the user equipment.

In the embodiment of the present invention, optionally, as shown in FIG. 8, the method 200 for processing QoS further includes the following steps.

S251: Receive a user information inquiring request sent by the application server, where the user information inquiring request includes an identifier of the user equipment.

S252: Determine, according to the identifier of the user equipment, the initial QoS information, where the initial QoS information includes available QoS information of the user equipment in the mobile network.

S253: Send a user information inquiring response to the application server, where the user information inquiring response includes the initial QoS information, so that the application server determines, according to the initial QoS information, whether to increase the QoS level of the user equipment.

It should be understood that, in the embodiment of the present invention, the QoS control network element may also notify the application server of the initial QoS information in another manner, for example, notifying the application server of the initial QoS information by invoking a QoS notification API. The present invention does not limit a specific notification manner.

In the embodiment of the present invention, optionally, the initial QoS information further includes: subscription QoS information of the user equipment in the mobile network and/or charging package information of the user equipment in the mobile network.

In the embodiment of the present invention, optionally, the QoS level of the user equipment includes a bandwidth allowed to be used by the user equipment, and/or a subscriber category of the user equipment.

Therefore, the QoS control network element sends the initial QoS information to the application server, so that the application server can determine, according to the initial QoS information, whether to increase the QoS level of the user equipment.

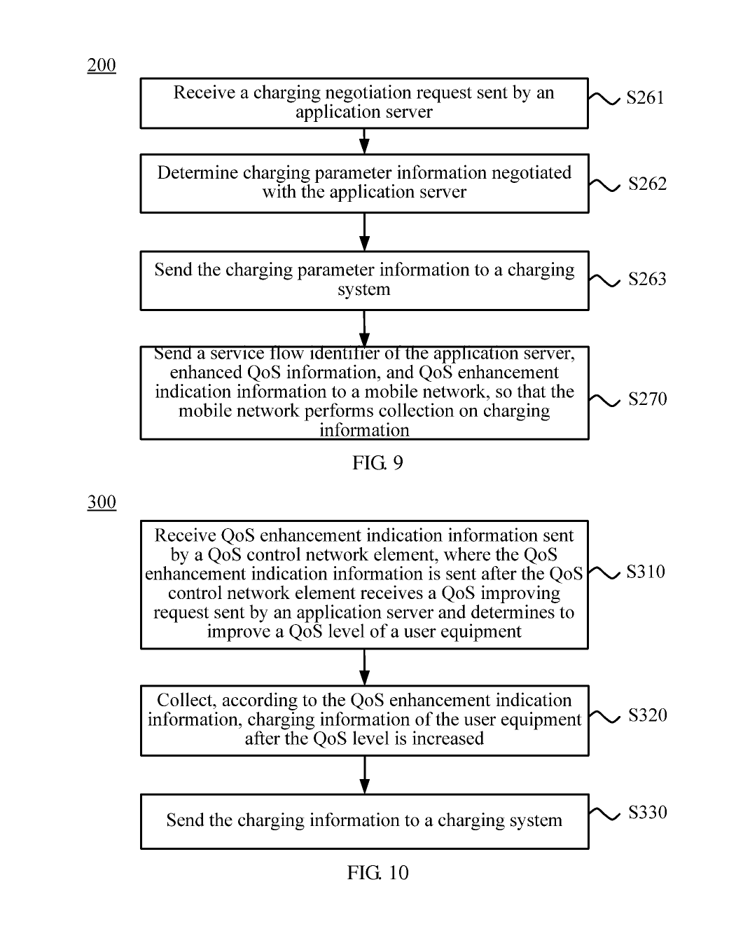

In the embodiment of the present invention, optionally, the method 200 shown in FIG. 9 further includes the following steps.

S261: Receive a charging negotiation request sent by the application server.

S262: Determine charging parameter information negotiated with the application server.

S263: Send the charging parameter information to a charging system.

In the embodiment of the present invention, the QoS control network element receives the charging negotiation request sent by the application server. The charging negotiation request includes, for example, a request for negotiating charging parameter information such as a charging mode, a measurement mode, and a charging package, where the charging mode includes, for example, an online mode and an offline mode; and the measurement mode includes, for example, a data volume, a data duration, the data volume and data duration, or another measurement event, so that the charging system can charge according to the enhanced QoS information.

It should be understood that, in the embodiment of the present invention, the application provider and the mobile operator may further negotiate the charging parameter information in another manner. For example, the application server obtains available charging parameter information (such as charging package information) from the mobile network (such as an open platform); the application server selects charging parameter information (for example, selecting a charging package); the application server notifies the mobile network (for example, notifying an open platform in the mobile network) of the selected charging parameter information, that is, the application provider obtains the available charging parameter information (such as the charging package information) from the mobile operator; the application provider selects charging parameter information (for example, selecting a charging package; and the application provider notifies the mobile operator of the selected charging parameter information.

As shown in FIG. 9, optionally, the method 200 further includes the following steps.

S270: Send a service flow identifier of the application server, the enhanced QoS information, and QoS enhancement indication information to the mobile network, so that the mobile network performs collection on charging information.

The QoS control network element increases, according to the QoS improving request submitted by the third-party application, the QoS level of the user equipment, to ensure QoS guarantee of the service request. This process further needs some enhanced processing. The QoS control network element notifies the mobile network of the service flow identifier of the application, the enhanced QoS information, and the QoS enhancement indication information. The service flow identifier is, for example, a quintuple, which includes a source IP address, a destination IP address, a source port number, a destination port number, and a protocol type.

The mobile network may perform, according to the QoS enhancement indication information, the following enhancement processing: a gateway device of the mobile network collects charging information after the current increasing the QoS level of the user equipment, where the charging information is, for example, a data duration, a data volume, or the data duration and data volume of an application performed by the user equipment, and event information about the current increasing the QoS level of the user equipment, and sends the collected charging information to the charging system after the application is finished. For online charging, the mobile operator directly deducts a fee for the current increasing the QoS level of the user equipment from balance of the application provider; and for offline charging, the charging system generates a charging bill for a current temporarily applied bandwidth, and notifies the application provider of the charging bill. After the mobile network collects the charging information, the QoS control network element sends the current charging information to the application server.

It should be understood that, interaction, related features, and functions between the application server and the QoS control network element described from the perspective of the application server side are corresponding to descriptions from the perspective of the QoS control network element side, which, for brevity, are not described herein again.

It should be understood that, in the embodiment of the present invention, information may be transmitted between network elements through a message interface, or transmitted through an API interface, and may also be transmitted through an interface of another type, and the embodiment of the present invention is not limited thereto.

It should be further understood that in the embodiments of the present invention, serial numbers of the above processes do not indicate an execution sequence. The execution sequence of the processes should be determined based on functions and internal logic thereof, and should not constitute any limitation on an implementation process of the embodiments of the present invention.

Therefore, in the method for processing quality of service according to the embodiment of the present invention, the application server requests the QoS control network element to increase the QoS level of the user equipment, so that the mobile network can dynamically adjust the QoS level of the user equipment, thereby improving user experience, and facilitating promotion of the application service.

The method for processing quality of service according to the embodiment of the present invention is described above from the perspective of the application server and the QoS control network element respectively with reference to FIG. 1 to FIG. 9. The following describes the method for processing quality of service according to the embodiment of the present invention from the perspective of a mobile network with reference to FIG. 10.

As shown in FIG. 10, a method 300 for processing quality of service according to the embodiment of the present invention may be executed by a mobile network, for example, executed by an SAE network. The method 300 includes the following steps.

S310: Receive QoS enhancement indication information sent by a QoS control network element, where the QoS enhancement indication information is sent after the QoS control network element receives a QoS improving request sent by an application server and determines to increase a QoS level of a user equipment.

S320: Collect, according to the QoS enhancement indication information, charging information of the user equipment after the QoS level is increased.

S330: Send the charging information to a charging system.

In the embodiment of the present invention, optionally, the charging information includes a data duration applied by the user equipment after the QoS level is increased and/or a data volume applied by the user equipment after the QoS level is increased. Optionally, the QoS level of the user equipment includes a bandwidth allowed to be used by the user equipment, and/or a subscriber category of the user equipment.

Specifically, after the QoS control network element receives the QoS improving request sent by the application server and determines to increase the QoS level of the user equipment, the QoS enhancement indication information sent by the QoS control network element is received. The mobile network may perform, according to the QoS enhancement indication information, the following enhancement processing: a gateway device of the mobile network collects the charging information after the current increasing the QoS level of the user equipment, where the charging information is, for example, a data duration, a data volume, or the data duration and data volume of an application performed by the user equipment, and event information about the current increasing the QoS level of the user equipment, and sends the collected charging information to the charging system after the application is finished.

It should be understood that, for online charging, the mobile operator directly deducts a fee for the current increasing the QoS level of the user equipment from balance of the application provider; and for offline charging, the charging system generates a charging bill for a current temporarily applied bandwidth, and notifies the application provider of the charging bill.

It should be understood that, in the embodiment of the present invention, information may be transmitted between network elements through a message interface, or transmitted through an API interface, and may also be transmitted through an interface of another type, and the embodiment of the present invention is not limited thereto.

It should be understood that, interaction, related features and functions with the mobile network described from the perspective of the application server side and the QoS control network element are corresponding to descriptions from the perspective of the mobile network side, which, for brevity, are not described herein again.

It should be further understood that in the embodiments of the present invention, serial numbers of the above processes do not indicate an execution sequence. The execution sequence of the processes should be determined based on functions and internal logic thereof, and should not constitute any limitation on an implementation process of the embodiments of the present invention.

Therefore, in the method for processing quality of service according to the embodiment of the present invention, the application server requests the QoS control network element to increase the QoS level of the user equipment, so that the mobile network can dynamically adjust the QoS level of the user equipment, thereby improving user experience, and facilitating promotion of the application service.

FIG. 11 shows a schematic flowchart of a method 400 for processing QoS according to an embodiment of the present invention. As shown in FIG. 11, the method 400 for processing QoS may start from S401 to S405, and then from S441 to S448; and the method 400 may also start from S421 to S423, and then from S441 to S448.

In S401, a mobile network reports network capability information to a QoS control network element. The QoS control network element may be a network element such as a PCRF, a service gateway, a capability open platform, or a service development platform; and the network capability information includes information such as a network load or network capability. If the QoS control network element already has the network capability information, this step is unnecessary.

In S402, a user equipment initiates an application request to an application server to request for performing an application service. The application service is, for example, a video service. For an active pushing service initiated by the application server, this step is unnecessary.

In S403, the application server sends a service request to the QoS control network element, so as to request QoS needed by the service, where the service request may include, for example, a service identifier, a service type, and QoS (such as a bandwidth) needed by the service. For example, the application server may send, through a QoS request API, a service request to the QoS control network element.

In S404, the QoS control network element negotiates with the mobile network about the QoS that can be assigned to the requested service. A QoS control network may determine, based on the network load or network capability, the QoS that can be assigned by the mobile network. For example, if the network load is high, it may be determined that the mobile network assigns low QoS to the requested service; and if the network load is low, it may be determined that the mobile network assigns high QoS to the requested service.

In S405, the QoS control network element notifies the application server of the determined QoS information. The QoS control network element may also notify the application server of information such as subscription QoS information or a charging package of the user equipment in mobile network. For example, the QoS control network element may notify, through a QoS notification API, the application server of the determined QoS information.

In S421, the user equipment initiates an application request to the application server to request for performing an application service. The application service is, for example, a video service. For an active pushing service initiated by the application server, this step is unnecessary.

In S422, the application server sends a user information inquiring request to the QoS control network element, where the user information inquiring request may include information such as an identifier of the user equipment. For example, the application server may request, by invoking a user information inquiring request API, to request the mobile network to provide information of the user equipment.

In S423, the application server receives a user information inquiring response sent by the QoS control network element, where the user information inquiring response includes available QoS information of the user equipment in the mobile network. The user information inquiring response may further include subscription QoS information of the user equipment in the mobile network and/or charging package information of the user equipment in the mobile network. For example, the mobile network may notify, through a user information notification API, the application server of the information of the user equipment.

In S441, the application server (or, in other words, an application provider) determines to request the mobile network to increase the QoS level of the user equipment, and sends a QoS improving request to the QoS control network element. That the application server requests the mobile network to increase the QoS level of the user equipment includes: improving the bandwidth allowed to be used by the user equipment, and/or improving the subscriber category of the user equipment, for example, upgrading the subscriber category of the user equipment from a bronze user category to a silver user category or a gold user category.

A policy for the application server to determine whether to increase the QoS level of the user equipment is as follows: when the application server determines that assignment QoS information assigned by the mobile network or the available QoS information of the user equipment in the mobile network cannot meet a QoS demand required by the service, the application server determines to request the mobile network to increase the QoS level of the user equipment; or when the application server determines that the subscription QoS information (for example, the bandwidth or the subscriber category) of the user equipment in the mobile network or the charging package of the user equipment in the mobile network does not meet a QoS requirement that the application server guarantees to provide for the user equipment or a charging package requirement, the application server determines to request the mobile network to increase the QoS level of the user equipment.

For example, the application server may request, by invoking a QoS enhancement API, the mobile network to increase the QoS level of the user equipment.

In S442, the application provider and the mobile operator negotiate charging parameter information, for example, negotiating whether to charge according to a duration of enhanced QoS (for example, charging 0.1 CNY for 10 minutes of enhanced QoS), or charge according to the number of QoS enhanced times (for example, charging 0.1 CNY for one time of enhanced QoS). This step is also optional.

The charging parameter information negotiated between the application provider and the mobile operator may include: a charging mode (an online mode or an offline mode), a measurement mode (a data volume, a data duration, the data volume/duration combined, or an event), a charging package (for example, 10 yuan/100M/month or 1 yuan/one time of enhanced QoS), and so on. For example, the application server may negotiate the charging parameter information with the mobile operator by invoking a charging negotiation API.

In S443, the QoS control network element authenticates a charging negotiation API request submitted by the application server. If the mobile network receives the request submitted by the application server, the QoS control network element notifies the charging system of the negotiated charging parameter information.

In S444, the QoS control network element increases, according to the request submitted by the application server, the QoS level of the user equipment, so as to ensure QoS of the service request. This step needs some enhancement processing. The QoS control network element notifies the mobile network of a service flow identifier (for example, a quintuple (a source IP address, a destination IP address, a source port number, a destination port number, and a protocol type)) of the application service, the enhanced QoS information, and the QoS enhancement indication information.

In S445, the QoS control network element sends, through a QoS improving response, the determined enhanced QoS information to the application server.

In S446, the mobile network may perform, according to the QoS enhancement indication information, the following enhancement processing: a gateway device of the mobile network collects charging information after the current increasing of the QoS level of the user equipment, for example, a data duration, a data volume, or data duration/data volume combined information of an application performed by the user equipment, or event information about the current increasing the QoS level of the user equipment, and sends the collected charging information to the charging system after the application is finished.

In S447, for online charging, the mobile operator directly deducts a fee for the current increasing the QoS level of the user equipment from balance of the application provider; and for offline charging, the charging system generates a charging bill for the current temporarily applied bandwidth, and notifies the application provider of the charging bill. That is, the charging system sends a charging notification to the QoS control network element.

In S448, the QoS control network element sends the current charging information to the application server.

It should be understood that, in the embodiment of the present invention, information may be transmitted between network elements through a message interface, or transmitted through an API interface, and may also be transmitted through an interface of another type, and the embodiment of the present invention is not limited thereto.

It should be further understood that in the embodiments of the present invention, serial numbers of the above processes do not indicate an execution sequence. The execution sequence of the processes should be determined based on functions and internal logic thereof, and should not constitute any limitation on an implementation process of the embodiments of the present invention.

Therefore, in the method for processing quality of service according to the embodiment of the present invention, the application server requests the QoS control network element to increase the QoS level of the user equipment, so that the mobile network can dynamically adjust the QoS level of the user equipment, thereby improving user experience, and facilitating promotion of the application service.

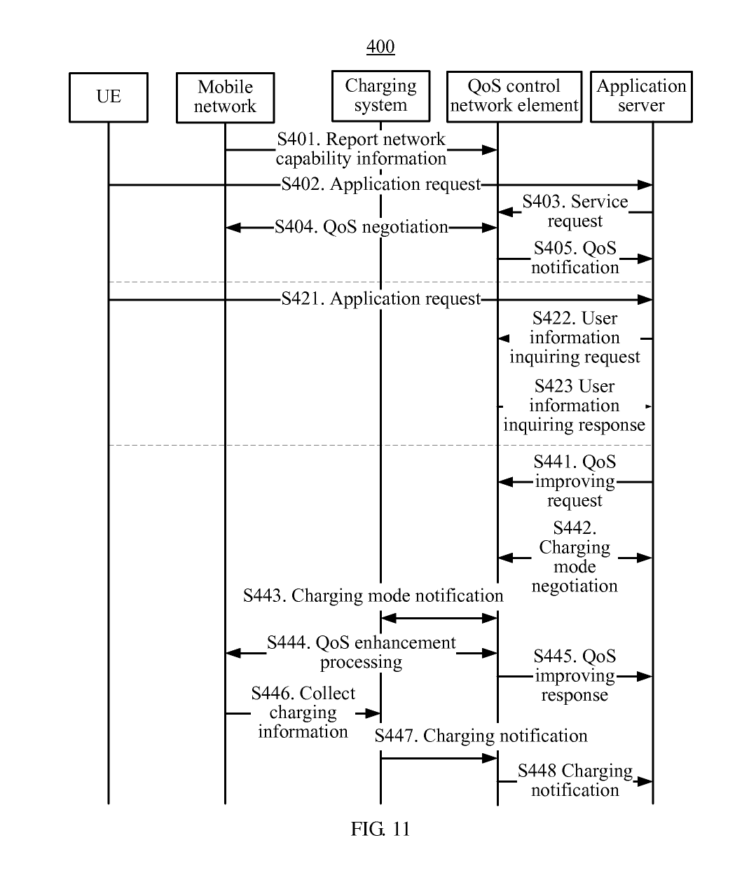

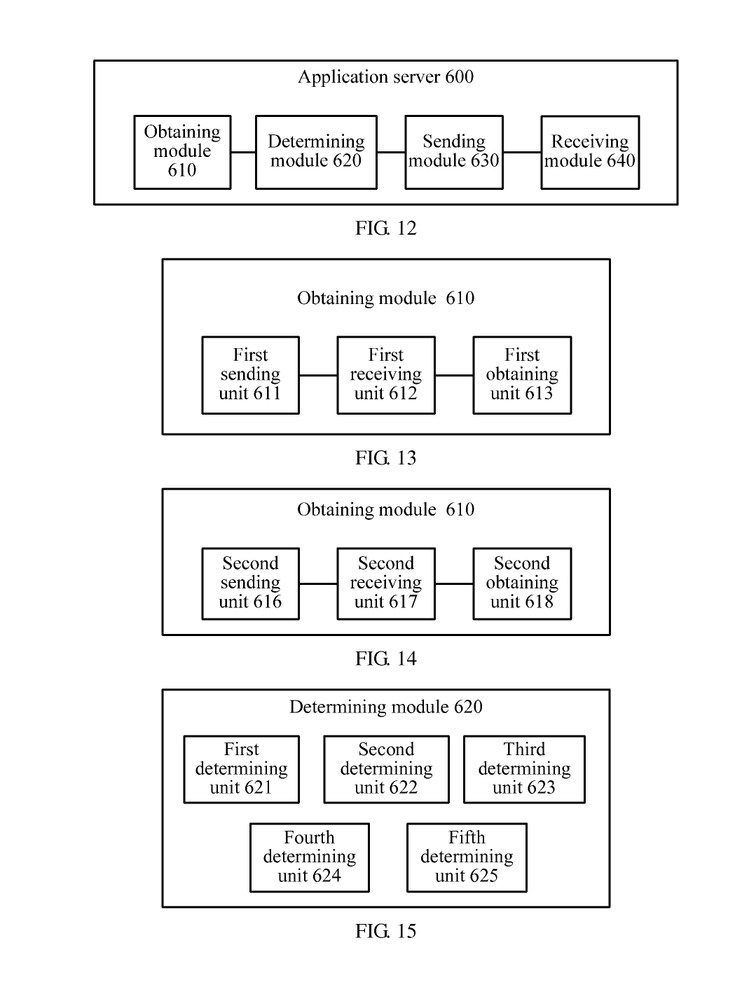

The method for processing quality of service according to the embodiment of the present invention is described above with reference to FIG. 1 to FIG. 11. The following describes an application server, a QoS control network element, and a mobile network according to the embodiments of the present invention with reference to FIG. 12 to FIG. 22.

FIG. 12 shows a schematic block diagram of an application server 600 according to an embodiment of the present invention. As shown in FIG. 12, the application server 600 includes an obtaining module 610 configured to obtain initial quality of service QoS information of a user equipment in a mobile network, a determining module 620 configured to determine, according to the initial QoS information, to request the mobile network to increase a QoS level of the user equipment, and a sending module 630, configured to send a QoS improving request to a QoS control network element. The QoS improving request is used to request for increasing the QoS level of the user equipment. A receiving module 640 is configured to receive a QoS improving response sent by the QoS control network element, where the QoS improving response includes enhanced QoS information assigned by the mobile network for the user equipment.

Therefore, in the application server according to the embodiment of the present invention, the application server requests the QoS control network element to increase the QoS level of the user equipment, so that the mobile network can dynamically adjust the QoS level of the user equipment, thereby improving user experience, and facilitating promotion of the application service.

Optionally, as shown in FIG. 13, the obtaining module 610 includes a first sending unit 611 configured to send a service request to the QoS control network element, a first receiving unit 612 configured to receive a service response sent by the QoS control network element. The service response includes assignment QoS information assigned by the mobile network for the user equipment. A first obtaining unit 613 is configured to obtain, according to the service response information, the initial QoS information including the assignment QoS information.

In the embodiment of the present invention, optionally, the service response received by the first receiving unit 612 further includes subscription QoS information of the user equipment in the mobile network and/or charging package information of the user equipment in the mobile network; and the initial QoS information obtained by the first obtaining unit 613 further includes the subscription QoS information and/or the charging package information.

Optionally, as shown in FIG. 14, the obtaining module 610 includes a second sending unit 616 configured to send a user information inquiring request to the QoS control network element. A second receiving unit 617 is configured to receive a user information inquiring response sent by the QoS control network element. The user information inquiring response includes available QoS information of the user equipment in the mobile network. A second obtaining unit 618 is configured to obtain, according to the user information inquiring response, the initial QoS information including the available QoS information.

In the embodiment of the present invention, optionally, the user information inquiring response received by the second receiving unit 617 further includes subscription QoS information of the user equipment in the mobile network and/or charging package information of the user equipment in the mobile network; and the initial QoS information obtained by the second obtaining unit 618 further includes the subscription QoS information and/or the charging package information.

In the embodiment of the present invention, optionally, the determining module 620 is further configured to determine, according to the initial QoS information and a preset rule, to request the mobile network to increase the QoS level of the user equipment.

In the embodiment of the present invention, optionally, as shown in FIG. 15, the determining module 620 includes a first determining unit 621, configured to determine to request the mobile network to increase the QoS level of the user equipment when the assignment QoS information, included in the initial QoS information and assigned by the mobile network for the user equipment, does not meet a QoS demand of a service.

Optionally, as shown in FIG. 15, the determining module 620 includes a second determining unit 622, configured to determine to request the mobile network to increase the QoS level of the user equipment when the available QoS information, included in the initial QoS information, of the user equipment in the mobile network does not meet a QoS demand of a service.

Optionally, as shown in FIG. 15, the determining module 620 includes a third determining unit 623, configured to determine to request the mobile network to increase the QoS level of the user equipment when the subscription QoS information, included in the initial QoS information, of the user equipment in the mobile network does not meet a QoS demand of a service.

Optionally, as shown in FIG. 15, the determining module 620 includes a fourth determining unit 624, configured to determine to request the mobile network to increase the QoS level of the user equipment when the charging package information included in the initial QoS information does not meet a charging package requirement.

Optionally, as shown in FIG. 15, the determining module 620 includes a fifth determining unit 625, configured to determine, according to the initial QoS information, to request the mobile network to increase a bandwidth allowed to be used by the user equipment, and/or to increase a subscriber category of the user equipment.

It should be understood that, the determining module 620 may include one or more of the above determining units, and the embodiment of the present invention is not limited thereto.

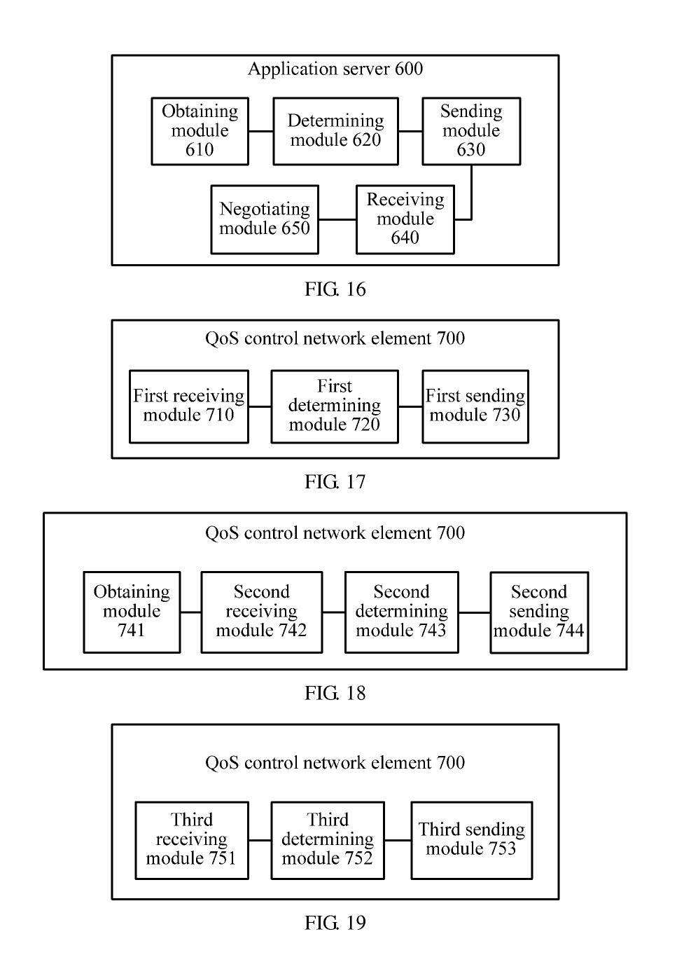

In the embodiment of the present invention, optionally, as shown in FIG. 16, the application server 600 further includes a negotiating module 650 configured to send a charging negotiation request to the QoS control network element, so as to negotiate charging parameter information with the mobile network.

In the embodiment of the present invention, the application server may be a video server, or may also be an FTP server. The FTP server is a dedicated server for providing various files for a user. The FTP server usually stores a large amount of files, for example, software, MP3, movies, and programs. The application server may also be a mail server or another server, and the present invention is not limited thereto.

It should be understood that, the application server 600 according to the embodiment of the present invention may correspond to the application server or third-party application in the embodiments of the present invention. Moreover, the above and other operations and/or functions of the modules in the application server 600 are respectively used to implement corresponding processes of the methods in FIG. 1 to FIG. 11, which, for brevity, are not described herein again.

Therefore, in the application server according to the embodiment of the present invention, the application server requests the QoS control network element to increase the QoS level of the user equipment, so that the mobile network can dynamically adjust the QoS level of the user equipment, thereby improving user experience, and facilitating promotion of the application service.

FIG. 17 shows a schematic block diagram of a QoS control network element 700 according to an embodiment of the present invention. As shown in FIG. 17, the QoS control network element 700 includes a first receiving module 710 configured to receive a QoS improving request sent by an application server, where the QoS improving request is used to request a mobile network to increase a QoS level of a user equipment. A first determining module 720 is configured to determine, according to the QoS improving request and a QoS enhancement protocol between the application server and the mobile network, enhanced QoS information assigned by the mobile network for the user equipment. A first sending module 730 is configured to send a QoS improving response to the application server, where the QoS improving response includes the enhanced QoS information.

Therefore, in the QoS control network element according to the embodiment of the present invention, the application server requests the QoS control network element to increase the QoS level of the user equipment, so that the mobile network can dynamically adjust the QoS level of the user equipment, thereby improving user experience, and facilitating promotion of the application service.

In the embodiment of the present invention, optionally, as shown in FIG. 18, the QoS control network element 700 further includes an obtaining module 741, configured to obtain network capability information of the mobile network. A second receiving module 742 is configured to receive a service request sent by the application server, where the service request includes QoS needed for executing a service by the user equipment. A second determining module 743 is configured to determine, according to the network capability information and the service request, the initial QoS information. The initial QoS information includes assignment QoS information assigned by the mobile network for the user equipment. A second sending module 744 is configured to send a service response to the application server, where the service response includes the initial QoS information, so that the application server determines, according to the initial QoS information, whether to increase a QoS level of the user equipment.

Optionally, the network capability information obtained by the obtaining module 741 includes at least one of load information of a cell, load information of an access network element, QoS supported by an access network, load information of gateway network element, and QoS supported by a gateway network element.

In the embodiment of the present invention, optionally, as shown in FIG. 19, the QoS control network element 700 further includes a third receiving module 751, configured to receive a user information inquiring request sent by the application server, where the user information inquiring request includes an identifier of the user equipment. A third determining module 752 is configured to determine, according to the identifier of the user equipment, the initial QoS information, where the initial QoS information includes available QoS information of the user equipment in the mobile network. A third sending module 753 is configured to send a user information inquiring response to the application server, where the user information inquiring response includes the initial QoS information, so that the application server determines, according to the initial QoS information, whether to increase the QoS level of the user equipment.

Optionally, the initial QoS information further includes: subscription QoS information of the user equipment in the mobile network and/or charging package information of the user equipment in the mobile network.

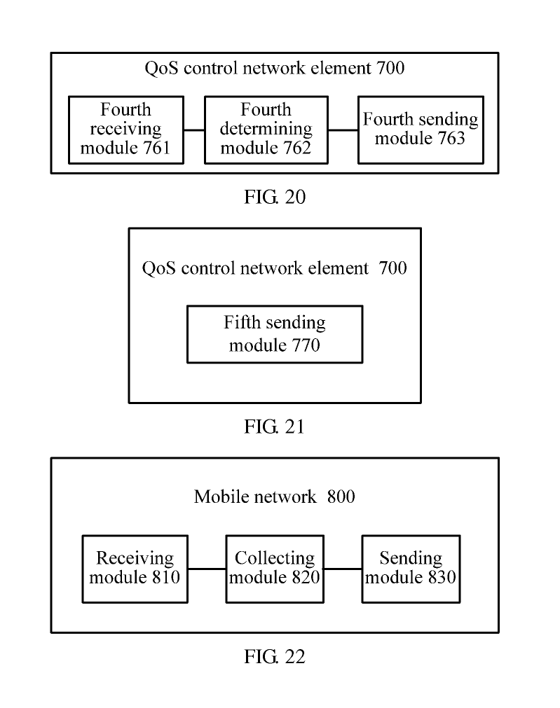

Optionally, as shown in FIG. 20, the QoS control network element 700 further includes a fourth receiving module 761, configured to receive a charging negotiation request sent by the application server. A fourth determining module 762 is configured to determine charging parameter information negotiated with the application server. A fourth sending module 763 is configured to send the charging parameter information to a charging system.

Optionally, as shown in FIG. 21, the QoS control network element 700 further includes a fifth sending module 770 configured to send a service flow identifier of the application server, the enhanced QoS information, and QoS enhancement indication information to the mobile network, so that the mobile network performs collection on charging information.

Optionally, the QoS level of the user equipment includes a bandwidth allowed to be used by the user equipment, and/or a subscriber category of the user equipment. Optionally, the QoS enhancement protocol includes: a QoS enhanced charging package between the application server and the mobile network.

In the embodiment of the present invention, the QoS control network element may be a network element such as a PCRF, a service gateway, a capability development platform, or a service development platform, but the present invention is not limited thereto.

It should be understood that, the QoS control network element 700 according to the embodiment of the present invention may correspond to the QoS control network element in the embodiments of the present invention, or correspond to a network element such as the PCRF, service gateway, capability development platform, or service development platform. Moreover, the above and other operations and/or functions of the modules in the QoS control network element 700 are respectively used to implement corresponding processes of the methods in FIG. 1 to FIG. 11, which, for brevity, are not described herein again.

Therefore, in the QoS control network element according to the embodiment of the present invention, the QoS control network element receives the request, sent by the application server, for improving the QoS level of the user equipment, so that the mobile network can dynamically adjust the QoS level of the user equipment, thereby improving user experience, and facilitating promotion of the application service.

FIG. 22 shows a schematic block diagram of a mobile network 800 according to an embodiment of the present invention. As shown in FIG. 22, the mobile network 800 includes a receiving module 810 configured to receive QoS enhancement indication information sent by a QoS control network element, where the QoS enhancement indication information is sent after the QoS control network element receives a QoS improving request sent by an application server and determines to increase a QoS level of a user equipment. A collecting module 820 is configured to collect, according to the QoS enhancement indication information, charging information of the user equipment after the QoS level is increased. A sending module 830 is configured to send the charging information to a charging system.

Optionally, the charging information collected by the collecting module 820 includes a data duration applied by the user equipment after the QoS level is increased and/or a data volume applied by the user equipment after the QoS level is increased.

Optionally, the QoS level of the user equipment includes a bandwidth allowed to be used by the user equipment, and/or a subscriber category of the user equipment.

In the embodiment of the present invention, the mobile network may be, for example, an SAE network or an SAE system, and may also be an LTE system, and so on, and the present invention is not limited thereto.

It should be understood that, the mobile network 800 according to the embodiment of the present invention may correspond to the mobile network in the embodiments of the present invention. Moreover, the above and other operations and/or functions of the modules in the mobile network 800 are used to implement corresponding processes of the methods in FIG. 1 to FIG. 11, which, for brevity, are not described herein again.

Therefore, in the mobile network according to the embodiment of the present invention, the application server requests the QoS control network element to increase the QoS level of the user equipment, so that the mobile network can dynamically adjust the QoS level of the user equipment, thereby improving user experience, and facilitating promotion of the application service.

A person of ordinary skill in the art may be aware that, in combination with the examples described in the embodiments disclosed in this specification, units and algorithm steps may be implemented by electronic hardware, or a combination of computer software and electronic hardware. To clearly describe interchangeability between hardware and software, compositions and steps of the examples have been generally described according to functions in the foregoing descriptions. Whether the functions are performed by hardware or software depends on particular applications and design constraint conditions of the technical solutions. A person skilled in the art may use different methods to implement the described functions for each particular application, but it should not be considered that the implementation goes beyond the scope of the present invention.

It may be clearly understood by a person skilled in the art that, for the purpose of convenient and brief description, for a detailed working process of the foregoing system, apparatus, and unit, reference may be made to a corresponding process in the foregoing method embodiments, and details are not described herein again.

In the several embodiments provided in the present application, it should be understood that the disclosed system, apparatus, and method may be implemented in other manners. For example, the described apparatus embodiment is merely exemplary. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed to a plurality of network units. A part or all of the units may be selected according to actual needs to achieve the objectives of the solutions of the embodiments.

In addition, functional units in the embodiments of the present invention may be integrated into one processing unit or, or each of the units may exist alone physically, or two or more units are integrated into one unit. The integrated units may be implemented through hardware, or may also be implemented in a form of a software functional unit.

When the integrated units are implemented in the form of a software functional unit and sold or used as an independent product, the integrated units may be stored in a computer-readable storage medium. Based on such understanding, the technical solutions of the present invention essentially, or the part contributing to the prior art, or a part of technical solutions may be implemented in a form of a software product. The computer software product is stored in a storage medium, and includes several instructions for instructing a computer device (which may be a personal computer, a server, or a network device) to perform all or a part of the steps of the methods described in the embodiments of the present invention. The foregoing storage medium includes: any medium that can store program code, such as a USB flash drive, a removable hard disk, a read-only memory (ROM, Read-Only Memory), a random access memory (RAM, Random Access Memory), a magnetic disc, or an optical disc.

The foregoing descriptions are merely specific embodiments of the present invention, but are not intended to limit the protection scope of the present invention. Any equivalent modifications or replacements readily figured out by a person skilled in the art within the technical scope disclosed in the present invention shall fall within the protection scope of the present invention. Therefore, the protection scope of the present invention shall be subject to the protection scope of the claims.

What is claimed is:

1. A method for processing quality of service, the method comprising:
obtaining initial quality of service (QoS) information of a user equipment in a mobile network;
determining, according to the initial QoS information, to request the mobile network to increase a QoS level of the user equipment;
sending a QoS improving request to a QoS control network element, wherein the QoS improving request is used to request for increasing the QoS level of the user equipment; and
receiving a QoS improving response sent by the QoS control network element, wherein the QoS improving response comprises enhanced QoS information assigned by the mobile network for the user equipment.

2. The method according to claim 1, wherein the obtaining initial quality of service QoS information of a user equipment in a mobile network comprises:
sending a service request to the QoS control network element;
receiving a service response sent by the QoS control network element, wherein the service response comprises assignment QoS information assigned by the mobile network for the user equipment; and
obtaining, according to the service response, the initial QoS information comprising the assignment QoS information.

3. The method according to claim 2, wherein the the service response further comprises subscription QoS information of the user equipment in the mobile network and/or charging package information of the user equipment in the mobile network; and the initial QoS information further comprises the subscription QoS information and/or the charging package information.

4. The method according to claim 1, wherein the obtaining initial quality of service QoS information of a user equipment in a mobile network comprises:
sending a user information inquiring request to the QoS control network element;
receiving a user information inquiring response sent by the QoS control network element, wherein the user information inquiring response comprises available QoS information of the user equipment in the mobile network; and
obtaining, according to the user information inquiring response, the initial QoS information comprising the available QoS information.

5. The method according to claim 4, wherein the user information inquiring response further comprises subscription QoS information of the user equipment in the mobile network and/or charging package information of the user equipment in the mobile network; and the initial QoS information further comprises the subscription QoS information and/or the charging package information.

6. The method according to claim 1, wherein the determining according to the initial QoS information to request the mobile network to increase a QoS level of the user equipment comprises:
determining, according to the initial QoS information and a preset rule, to request the mobile network to increase the QoS level of the user equipment.

7. The method according to claim 1, wherein the determining according to the initial QoS information to request the mobile network to increase a QoS level of the user equipment comprises:
when the assignment QoS information, comprised in the initial QoS information and assigned by the mobile network for the user equipment, does not meet a QoS demand of a service, determining to request the mobile network to increase the QoS level of the user equipment; or
when an available QoS information, comprised in the initial QoS information, of the user equipment in the mobile network does not meet a QoS demand of a service, determining to request the mobile network to increase the QoS level of the user equipment; or
when subscription QoS information, comprised in the initial QoS information, of the user equipment in the mobile network does not meet a QoS demand of a service, determining to request the mobile network to increase the QoS level of the user equipment; or
when charging package information comprised in the initial QoS information does not meet a charging package requirement, determining to request the mobile network to increase the QoS level of the user equipment.

8. The method according to claim 1, wherein the determining according to the initial QoS information to request the mobile network to increase a QoS level of the user equipment comprises:
determining, according to the initial QoS information, to request the mobile network to increase a bandwidth allowed to be used by the user equipment, and/or to increase a subscriber category of the user equipment.

9. The method according to claim 1, further comprising:
sending a charging negotiation request to the QoS control network element, so as to negotiate charging parameter information with the mobile network.

10. A method for processing quality of service, the method comprising:
receiving a quality of service (QoS) improving request sent by an application server, wherein the QoS improving request is used to request a mobile network to increase a QoS level of a user equipment;
determining, according to the QoS improving request and a QoS enhancement protocol between the application server and the mobile network, enhanced QoS information assigned by the mobile network for the user equipment; and
sending a QoS improving response to the application server, wherein the QoS improving response comprises the enhanced QoS information.

11. The method according to claim 10, further comprising:
obtaining network capability information of the mobile network;
receiving a service request sent by the application server, wherein the service request comprises QoS needed by the user equipment for executing a service;
determining initial QoS information according to the network capability information and the service request, wherein the initial QoS information comprises assignment QoS information assigned by the mobile network for the user equipment; and
sending a service response to the application server, wherein the service response comprises the initial QoS information, so that the application server determines, according to the initial QoS information, whether to increase the QoS level of the user equipment.

12. The method according to claim 11, wherein the network capability information comprises at least one of load information of a cell, load information of an access network element, QoS supported by an access network, load information of a gateway network element, and QoS supported by a gateway network element.

13. The method according to claim 11, wherein the initial QoS information further comprises: subscription QoS information of the user equipment in the mobile network and/or charging package information of the user equipment in the mobile network.

14. The method according to claim 10, further comprising:
receiving a user information inquiring request sent by the application server, wherein the user information inquiring request comprises an identifier of the user equipment;
determining the initial QoS information according to the identifier of the user equipment, wherein the initial QoS information comprises available QoS information of the user equipment in the mobile network; and
sending a user information inquiring response to the application server, wherein the user information inquiring response comprises the initial QoS information, so that the application server determines, according to the initial QoS information, whether to increase the QoS level of the user equipment.

15. The method according to claim 10, further comprising:
receiving a charging negotiation request sent by the application server;
determining charging parameter information negotiated with the application server; and
sending the charging parameter information to a charging system.

16. The method according to claim 10, further comprising:
sending a service flow identifier of the application server, the enhanced QoS information, and QoS enhancement indication information to the mobile network, so that the mobile network performs collection on charging information.

17. The method according to claim 10, wherein the QoS level of the user equipment comprises a bandwidth allowed to be used by the user equipment, and/or a subscriber category of the user equipment.

18. A method for processing quality of service, the method comprising:
receiving quality of service (QoS) enhancement indication information sent by a QoS control network element, wherein the QoS enhancement indication information is sent after the QoS control network element receives a QoS improving request sent by an application server and determines to increase a QoS level of a user equipment;
collecting, according to the QoS enhancement indication information, charging information of the user equipment after the QoS level is increased; and
sending the charging information to a charging system.

19. The method according to claim 18, wherein the charging information comprises a data duration applied by the user equipment after the QoS level is increased and/or a data volume applied by the user equipment after the QoS level is increased.

20. The method according to claim 18, wherein the QoS level of the user equipment comprises a bandwidth allowed to be used by the user equipment, and/or a subscriber category of the user equipment.
